(19) United States
(12) Patent Application Publication
(10) Pub. No.: US 2026/0264559 A1
(43) Pub. Date: Sep. 10, 2026

(54) SYSTEMS AND METHODS FOR CONTROLLING A CHARGING SESSION

(71) Applicant: ABB E-Mobility B.V., Delft (NL)

(72) Inventor: Brecht BAETEN, Oudsbergen (BE)

(73) Assignee: ABB E-Mobility B.V., Delft (NL)

(21) Appl. No.: 19/165,979

(22) PCT Filed: Mar. 16, 2023
(86) PCT No.: PCT/EP2023/056717

§ 371 Date: Sep. 16, 2025

(51) Int. Cl. B60L 53/64; B60L 53/62; G06Q 30/0283

(52) U.S. Cl. CPC B60L 53/64; B60L 53/62; G06Q 30/0283

(57) ABSTRACT

A charging control computing device for controlling charging of an energy storage device is provided. The charging control computing device includes a processor in communication with a memory device. The processor is configured to receive a charging request for the energy storage device, compute an extra charge amount by which to increase a charging limit of the energy storage device that minimizes a total expected power cost for a time period using an optimization algorithm, compute a charging limit based on an initial charging limit and the extra charge amount, and limit charge of the energy storage device to at or below the charging limit.

### BACKGROUND

The field of the invention relates generally to controlling a charging session, and more particularly, for controlling charging to reduce a cost of acquiring energy from a grid.

Electric vehicles offer many environmental and performance benefits over fossil-fuel powered vehicles. Electric vehicles include batteries that must be charged periodically to provide electric power for the electric vehicle. When charged at home, electric vehicles consume a significant amount of electrical power. As such, when power is purchased from a grid, charging the electric vehicle may come at a significant financial cost. This cost may depend on factors such as a price of purchasing power from or selling power to the grid, or an availability of power from alternative sources (e.g., solar panels), each of which may fluctuate over time. A system that schedules charging sessions based on these fluctuations to reduce the cost of charging an electric vehicle over time is therefore desirable.

### BRIEF DESCRIPTION

In one aspect, a charging control computing device for controlling charging of an energy storage device is provided. The charging control computing device includes a processor in communication with a memory device. The processor is configured to receive a charging request for the energy storage device, compute an extra charge amount by which to increase a charging limit of the energy storage device that minimizes a total expected power cost for a time period using an optimization algorithm, compute a charging limit based on an initial charging limit and the extra charge amount, and limit charge of the energy storage device to at or below the charging limit.

In another aspect, a method for controlling charging of an energy storage device is provided. The method is performed by a charging control computing device including a processor in communication with a memory device. The method includes receiving a charging request for the energy storage device, computing an extra charge amount by which to increase a charging limit of the energy storage device that minimizes a total expected power cost for a time period using an optimization algorithm, computing a charging limit based on an initial charging limit and the extra charge amount, and limiting charge of the energy storage device to at or below the charging limit.

In another aspect, an electric vehicle is provided. The electric vehicle includes an energy storage device and a charging control computing device for controlling charging of the energy storage device. The charging control computing device includes a processor in communication with a memory device. The processor is configured to receive a charging request for the energy storage device, compute an extra charge amount by which to increase a charging limit of the energy storage device that minimizes a total expected power cost for a time period using an optimization algorithm, compute a charging limit based on an initial charging limit and the extra charge amount, and limit charge of the energy storage device to at or below the charging limit.

### BRIEF DESCRIPTION OF THE DRAWINGS

FIG. 1 is a block diagram illustrating an example system for charging an energy storage device of an electric vehicle.

FIG. 2 is a flow chart illustrating an example method for controlling charging of an energy storage device such as the energy storage device shown in FIG. 1.

FIG. 3 is a block diagram of an example computing device for use in the system shown in FIG. 1.

### DETAILED DESCRIPTION

Example embodiments of the present disclosure include a charging control computing device for controlling charging of an energy storage device, such as a battery of an electric vehicle. The charging control computing device is configured to impose a charging limit, or a maximum charge level to which the energy storage device may be charged before the charging control computing device ceases charging of the energy storage device. Generally, an initial charging limit is set based on an expected discharge of the energy storage device before recharging. The charging limit may be increased by an amount, referred to herein as an “extra charge amount,” to reduce a cost of charging the energy storage device over time by taking advantage of changes in the price of purchasing power from a grid and utilizing local renewable sources of power.

In the example embodiments, the charging control computing device is configured to receive a charging request for the energy storage device and compute the extra charge amount by which to increase the charging limit of the energy storage device that minimizes a total expected power cost for a time period using an optimization algorithm. The optimization algorithm is configured to output an extra charge amount based on one or more variables such as, for example, an expected cost of purchasing power during a future time period compared to an average long-term cost. The charging control computing device is configured to compute a charging limit based on an initial charging limit and the computed extra charge amount and limit charge of the energy storage device to at or below the charging limit.

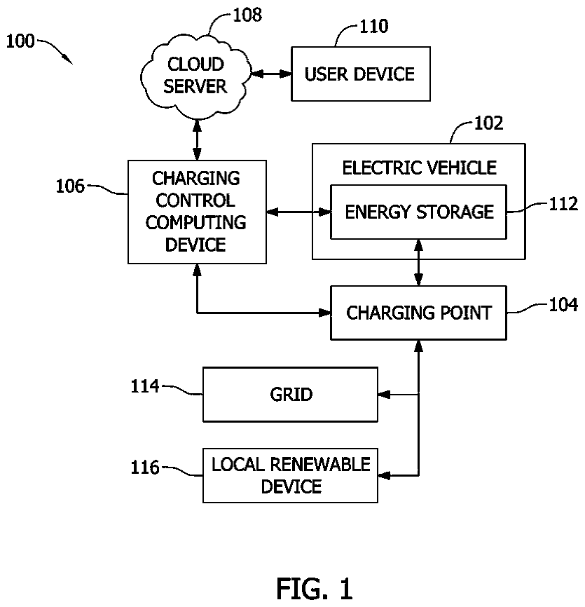

FIG. 1 is a block diagram of an example charging system 100. Charging system 100 includes an electric vehicle 102, a charging point 104, a charging control computing device 106, a cloud server 108, and a user device 110 (e.g., a personal computer (PC), smart phone, or tablet computer). Electric vehicle 102 includes an energy storage device 112, which stores electrical energy for operating electric vehicle 102. In some embodiments, energy storage device 112 is a battery or other device capable of storing electrical energy. While charging system 100 is depicted as being configured for controlling charging of energy storage device 112 of electric vehicle 102, in some implementations, charging system 100 may be configured for controlling charging of another type of energy storage device, such as a home battery or an energy storage system.

Charging point 104 is configured to provide electrical power obtained from, for example, a grid 114 and/or a local renewable source 116 for charging energy storage device 112. Charging point 104 is configured to control charging of energy storage device 112 by providing instructions to electric vehicle 102 and/or charging point 104. For example, in some embodiments, charging point 104 is configured to start charging, stop charging, control a rate of charging of, and/or measure a charge of energy storage device 112.

Charging control computing device 106 is configured to impose a charging limit on energy storage device 112 by disabling further charging of energy storage device 112 when a charge level of energy storage device 112 has reached the charging limit. In some embodiments, the charging limit is determined based on an expected discharge or usage of energy storage device for a given period. For example, if energy storage device 112 is typically recharged daily, the charging limit may be determined based on an average or estimated milage drive per day by electric vehicle 102. In some embodiments, the charging limit or milage can be input by the user, for example, using an application (“app”) executing on user device 110. As described in further detail below, charging control computing device 106 may adjust the charge limit, for example, to reduce a cost of purchasing electrical power from grid 114 to charge energy storage device 112 and/or to increase a proportion of renewable power that is used to charge energy storage device 112.

In some embodiments, charging control computing device 106 is integrated into one of electric vehicle 102 or charging point 104. Alternatively, charging control computing device 106 may be remote from electric vehicle 102 and/or charging point 104, and may communicate with electric vehicle 102 and/or charging point 104 via cloud server 108. For example, charging control computing device 106 may be integrated into a server computing device or user device 110.

Charging control computing device is configured to receive a charging request. For example, charging control computing device may detect a coupling of electric vehicle 102 to charging point 104 and/or receive a command to initiate charging from electric vehicle 102, charging point 104, and/or user device 110.

Charging control computing device 106 is further configured to compute an extra charge amount, or an amount by which to increase a charging limit of the energy storage device. As described in further detail below, the extra charge amount is computed using an optimization algorithm to reduce or minimize a total expected power cost for a time period.

In some embodiments, to compute the extra charge amount, charging control computing device 106 is configured to determine a cost of obtaining power from grid 114 (e.g., over a predefined future time period). The cost of obtaining power from grid 114 may be defined as, for a time period including a plurality of time increments, a sum, across each time increment, of a product of an amount of power to be purchased times the price of purchasing power. The time period may be a predefined future period, such as a 48 hour horizon, during which the price of obtaining power for grid 114 is predicted for each time increment. If the cost of purchasing power from grid 114 during the current charging session is below average, the extra charge amount may be increased to take advantage of the current, relatively low prices. Similarly, if a predicted price per unit energy of purchasing power for grid 114 is expected to be above average, or above the current price, the extra charge amount may be increased. Conversely, if current prices are high or are expected to fall in the near future, the extra charge amount may be decreased, or no extra charge may be added beyond the initial charging limit.

In some embodiments, to compute the extra charge amount, charging control computing device 106 is further configured to determine an expected value of power obtainable from local renewable source 116, which may offset the cost of purchasing power from grid 114. The value of power obtainable from a local renewable source 116 may be defined as, for a period including a plurality of time increments, a sum, across each time increment, of a product of an amount of power expected to be generated times the price of selling the generated power to grid 114. Similar to determining the cost of obtaining power from grid 114, the time period may be a predefined future period, such as a 48 hour horizon, during which the price of selling power to grid 114 is predicted for each time increment. If a greater value of renewable power is expected to be available and/or the cost of injecting power to grid 114 is expected to be relatively low during the current charging session, or a lesser value of renewable power is expected to be available and/or the cost of injecting power to grid 114 is expected to be relatively high during the next charging session, the extra energy amount may be increased.

The expected cost of obtaining power from grid 114 and the expected value of power obtainable from local renewable source 116 may be used to determine a net cost of obtaining power during the time period, for example, by subtracting the expected value of power obtainable from local renewable source 116 from the expected cost of obtaining power from grid 114. Accordingly, in some embodiments, the optimization algorithm can be represented by the following equation:

$$objective = net cost - extra charge amount * value of extra charge amount per unit$$

The value per unit of the extra charge amount is a predefined value. In some embodiments, the value per unit energy is selected to be, for example, at or just below a long-term average price per unit for charging energy storage device 112. As a result, the extra charge amount will increase when the price of purchasing energy from grid 114 is low and/or there is an excess of locally generated renewable energy.

In some embodiments, certain additional constraints may be placed on the optimization algorithm. For example, extra charging may only occur when power can be derived exclusively from renewable sources (e.g., to reduce or eliminate carbon dioxide or other undesirable emissions resulting from non-renewable power generation), or when the price of purchasing power is below a predefined threshold.

Charging control computing device 106 is further configured to compute a charging limit based on an initial charging limit and the extra charge amount, for example, by increasing the charging limit from the initial charging limit by the extra charge amount. Charging control computing device 106 is configured to limit charge (e.g., by providing instructions to electric vehicle 102 and/or charging point 104) of energy storage device 112 to the charging limit. The initial charging limit may be determined based on an expected discharge amount before the next charging session. For example, a user may input through user device 110 an expected milage to be driven using electric vehicle 102 before recharging, and the initial charging limit may be computed based on this expected milage. By increasing the charging limit, energy storage device 112 may not fully discharge fully before a next charging session, thereby reducing an amount of energy needed to recharge energy storage device 112. If the cost of obtaining electrical power have increased in the intervening period (i.e., between charge sessions), by providing additional charge when costs are less, the overall cost of charging energy storage device 112 over the two charging sessions is reduced.

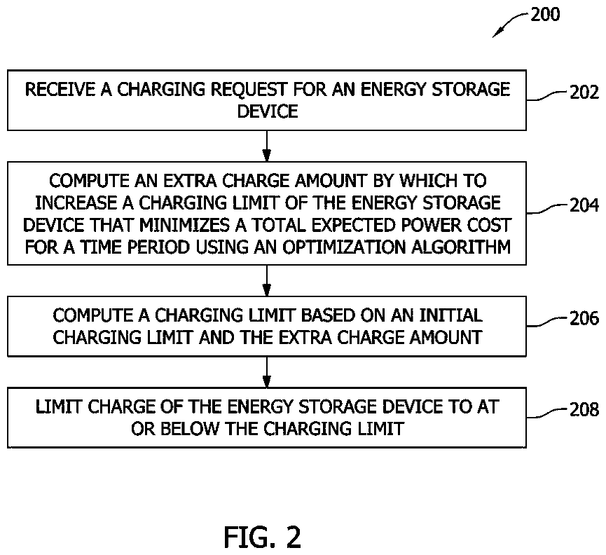

FIG. 2 is a flowchart illustrating an example method 200 for controlling charging of an energy storage device (such as energy storage device 112). In some embodiments, method 200 is performed by a charging control computing device (such as charging control computing device 106) including a processor in communication with a memory device. Method 200 includes 202 receiving a charge request from the energy storage device. Method 200 further includes computing 204 an extra charge amount by which to increase a charging limit of the energy storage device that minimizes a total expected power cost for a time period using an optimization algorithm. Method 200 further includes computing 206 a charging limit based on an initial charging limit and the extra charge amount. Method 200 further includes limiting 208 charge of the energy storage device to at or below the charging limit.

In some embodiments, computing 204 the extra charge amount includes determining a total expected cost of obtaining power from a grid (such as grid 114) during the time period and computing the extra charge amount using the total expected cost of obtaining power from the grid during the time period as an input to the optimization algorithm.

In some embodiments, computing 204 the extra charge amount includes determining a total expected value of power obtainable from a local renewable source (such as local renewable source 116) during the time period and computing the extra charge amount using the total expected value of power obtainable from a local renewable source during the time period as an input to the optimization algorithm.

In some embodiments, computing 204 the extra charge amount includes determine a value per unit of the extra charge amount and computing the extra charge amount using a value per unit of the extra charge amount as an input to the optimization algorithm. In some such embodiments, the value per unit of the extra charge amount is determined based on an average charging cost per unit of the energy storage device.

In some embodiments, the energy storage device is a battery of an electric vehicle (such as electric vehicle 102). In some such embodiments, the initial charging limit is determined as a function of an expected distance to be traveled by the electric vehicle prior to recharging.

In some embodiments, the initial charging limit is determined as a function of an expected discharge amount during a next discharge period.

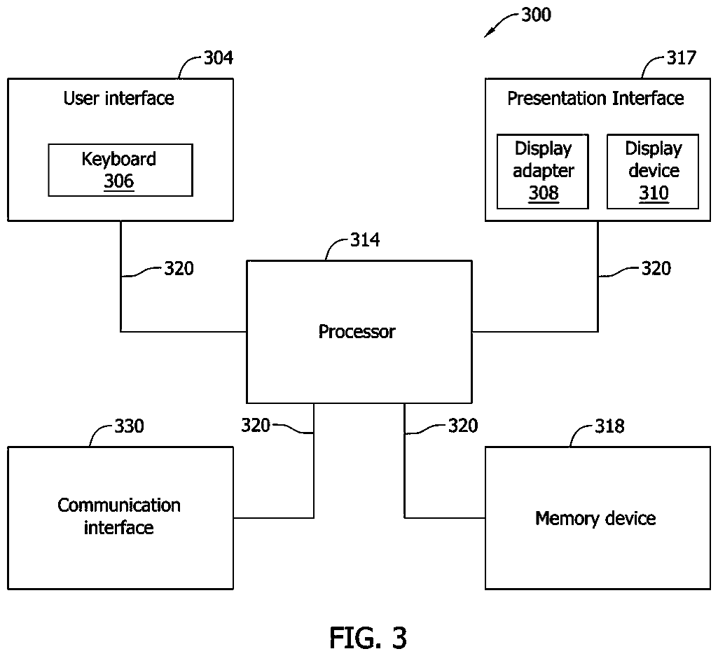

FIG. 3 is a block diagram of an example computing device 300, which represents an example implementation of charging control computing device 106 and/or user device 110. In the example embodiment, the computing device 300 includes a user interface 304 that receives at least one input from a user. The user interface 304 may include a keyboard 306 that enables the user to input pertinent information. The user interface 304 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 300 includes a presentation interface 317 that presents information, such as input events and/or validation results, to the user. The presentation interface 317 may also include a display adapter 808 that is coupled to at least one display device 310. More specifically, in the example embodiment, the display device 310 may be a visual display device, such as a cathode ray tube (CRT), a liquid crystal display (LCD), a light-emitting diode (LED) display, and/or an “electronic ink” display. Alternatively, the presentation interface 317 may include an audio output device (e.g., an audio adapter and/or a speaker) and/or a printer.

The computing device 300 also includes a processor 314 and a memory device 318. The processor 314 is coupled to the user interface 304, the presentation interface 317, and the memory device 318 via a system bus 320. In the example embodiment, the processor 314 communicates with the user, such as by prompting the user via the presentation interface 317 and/or by receiving user inputs via the user interface 304. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition and/or meaning of the term “processor.”

In the example embodiment, the memory device 318 includes one or more devices that enable information, such as executable instructions and/or other data, to be stored and retrieved. Moreover, the memory device 318 includes one or more computer readable media, such as, without limitation, dynamic random access memory (DRAM), static random access memory (SRAM), a solid state disk, and/or a hard disk. In the example embodiment, the memory device 318 stores, without limitation, application source code, application object code, configuration data, additional input events, application states, assertion statements, validation results, and/or any other type of data. The computing device 300, in the example embodiment, may also include a communication interface 330 that is coupled to the processor 314 via the system bus 820. Moreover, the communication interface 330 is communicatively coupled to data acquisition devices.

In the example embodiment, the processor 314 may be programmed by encoding an operation using one or more executable instructions and providing the executable instructions in the memory device 318. In the example embodiment, the processor 314 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

At least one technical effect of the systems and methods described herein includes (a) adjusting a charging limit of an energy storage device based on an optimization algorithm; and (b) improving utilization of local renewable energy sources for electric vehicle charging by increasing a charging limit of an energy storage device of the electric vehicle during periods in which renewable energy is available.

Example embodiments of systems and methods of controlling charging of an energy storage device are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A charging control computing device for controlling charging of an energy storage device, said charging control computing device comprising a processor in communication with a memory device, said processor configured to:
receive a charging request for the energy storage device;
compute an extra charge amount by which to increase a charging limit of the energy storage device that minimizes a total expected power cost for a time period using an optimization algorithm;
compute a charging limit based on an initial charging limit and the extra charge amount; and
limit charge of the energy storage device to at or below the charging limit.

2. The charging control computing device of claim 1, wherein to compute the extra charge amount, said processor is configured to:
determine a total expected cost of obtaining power from a grid during the time period; and
compute the extra charge amount using the total expected cost of obtaining power from the grid during the time period as an input to the optimization algorithm.

3. The charging control computing device of claim 1, wherein to compute the extra charge amount, said processor is configured to:
determine a total expected value of power obtainable from a local renewable source during the time period; and
compute the extra charge amount using the total expected value of power obtainable from a local renewable source during the time period as an input to the optimization algorithm.

4. The charging control computing device of claim 1, wherein to compute the extra charge amount, said processor is further configured to:
determine a value per unit of the extra charge amount; and
compute the extra charge amount using a value per unit of the extra charge amount as an input to the optimization algorithm.

5. The charging control computing device of claim 4, wherein the value per unit of the extra charge amount is determined based on an average charging cost per unit of the energy storage device.

6. The charging control computing device of claim 1, wherein the energy storage device is a battery of an electric vehicle.

7. The charging control computing device of claim 1, wherein the initial charging limit is determined as a function of an expected discharge amount during a next discharge period.

8. A method for controlling charging of an energy storage device, said method performed by a charging control computing device including a processor in communication with a memory device, said method comprising:
receiving a charging request for the energy storage device;
computing an extra charge amount by which to increase a charging limit of the energy storage device that minimizes a total expected power cost for a time period using an optimization algorithm;
computing a charging limit based on an initial charging limit and the extra charge amount; and
limiting charge of the energy storage device to at or below the charging limit.

9. The method of claim 8, wherein computing the extra charge amount comprises:
determining a total expected cost of obtaining power from a grid during the time period; and
computing the extra charge amount using the total expected cost of obtaining power from the grid during the time period as an input to the optimization algorithm.

10. The method of claim 8, wherein computing the extra charge amount comprises:
determining a total expected value of power obtainable from a local renewable source during the time period; and
computing the extra charge amount using the total expected value of power obtainable from a local renewable source during the time period as an input to the optimization algorithm.

11. The method of claim 8, wherein computing the extra charge amount comprises:
determining a value per unit of the extra charge amount; and
computing the extra charge amount using a value per unit of the extra charge amount as an input to the optimization algorithm.

12. The method of claim 11, wherein the value per unit of the extra charge amount is determined based on an average charging cost per unit of the energy storage device.

13. The method of claim 8, wherein the energy storage device is a battery of an electric vehicle.

14. The method of claim 8, wherein the initial charging limit is determined as a function of an expected discharge amount during a next discharge period.

15. An electric vehicle comprising:
an energy storage device; and
a charging control computing device for controlling charging of said energy storage device, said charging control computing device comprising a processor in communication with a memory device, said processor configured to:
receive a charging request for said energy storage device;
compute an extra charge amount by which to increase a charging limit of the energy storage device that minimizes a total expected power cost for a time period using an optimization algorithm;
compute a charging limit based on an initial charging limit and the extra charge amount; and
limit charge of said energy storage device to at or below the charging limit.

16. The electric vehicle of claim 15, wherein to compute the extra charge amount, said processor is configured to:
determine a total expected cost of obtaining power from a grid during the time period; and
compute the extra charge amount using the total expected cost of obtaining power from the grid during the time period as an input to the optimization algorithm.

17. The electric vehicle of claim 15, wherein to compute the extra charge amount, said processor is configured to:
determine a total expected value of power obtainable from a local renewable source during the time period; and
compute the extra charge amount using the total expected value of power obtainable from a local renewable source during the time period as an input to the optimization algorithm.

18. The electric vehicle of claim 15, wherein to compute the extra charge amount, said processor is further configured to:
determine a value per unit of the extra charge amount; and
compute the extra charge amount using a value per unit of the extra charge amount as an input to the optimization algorithm.

19. The electric vehicle of claim 16, wherein the value per unit of the extra charge amount is determined based on an average charging cost per unit of said energy storage device.

20. The electric vehicle of claim 15, wherein the initial charging limit is determined as a function of an expected distance to be traveled by said electric vehicle prior to recharging.
